(19) United States
(12) Patent Application Publication
(10) Pub. No.: US 2012/0192894 A1
(43) Pub. Date: Aug. 2, 2012

(54) CLEANING AND SEALING SOLUTION APPLICATOR TOOL FOR SURFACES SUCH AS STONE, POROUS TILE, OR GROUT

(75) Inventor: Brian A. KUBICEK, Woodbury, MN (US)

(73) Assignee: 3M Innovative Properties Company

(21) Appl. No.: 13/360,398

(22) Filed: Jan. 27, 2012

Related U.S. Application Data
(60) Provisional application No. 61/436,691, filed on Jan. 27, 2011.

(51) Int. Cl. B08B 1/04; B05C 1/06; B05C 17/005

(52) U.S. Cl. 134/6; 401/261; 401/190; 401/264

(57) ABSTRACT

A hand-held tool for applying a solution to grouted tile surfaces includes a container, a cap assembly, a head assembly and an applicator body. The container contains the solution and provides an exit port. The cap assembly is coupled to the container and forms a conduit fluidly open to the exit port. The head assembly is rotatably coupled to the cap assembly and defines a support face. An aperture is fluidly connected to the support face and the conduit. The applicator body is retained by the support face and forms a perimeter defining a major dimension greater than a minor dimension. Solution is delivered from the exit port to the applicator body by a pathway including the conduit and the aperture, with the pathway remaining open as the applicator body is rotated relative to the container. The tool can be especially useful with stone or porous tile surfaces.

### CROSS REFERENCE TO RELATED APPLICATION

This application claims priority under 35 U.S.C. §119(e)(1) to U.S. Provisional Patent Application No. 61/436,691, filed Jan. 27, 2011, entitled “Applicator Tools,” and the entire teachings of which are incorporated herein by reference.

### BACKGROUND

The present disclosure relates to hand-held tools or devices for applying a solution to a surface. More particularly, it relates to hand-held tools for containing and applying sealing or cleaning solutions to a hardened surface, for example a stone or porous tile grouted surface.

Tiled floors, walls or other surfaces are very popular in homes and commercial areas, providing a visually pleasing surface cover with high wear resistance. The tiles can be composed of various materials such as ceramic, porcelain, stone, clay, etc.). Unless otherwise indicated, the term “tile” as used in this disclosure is inclusive of all tile materials, including stone. Conventionally, the individual tiles are placed and secured to the surface to be covered (e.g., subfloor surface) in a spaced apart, side-to-side fashion to collectively form a desired pattern. Grout (e.g., cement) is then applied to the joint between the individual tiles. Once hardened, the grout serves as a finish between the tiles, and contributes to the overall visual effect of the resultant grouted tile surface. With many tiling techniques employing square or rectangular tile pieces, the applied grout forms a series grout lines that extend perpendicular relative to one another.

While wear resistant, the visual appearance of the tiled surface can diminish over time without proper care. For example, the applied grout can become stained, soiled or difficult to clean. Further, while glazed ceramic and similar tile formats are less likely to stain, other, more porous tile formats may require additional care. For example, porous tile (e.g., porcelain) and stone can become stained, soiled or rendered difficult to clean. To better protect the grout as well as porous tile and stone from soiling and discoloration, liquid sealing products have been developed and are commonly applied to the grout after hardening and/or the porous tile or stone (and later re-applied if deemed necessary). Also, many liquid cleaning products for grouted tile surfaces (including stone or porous tile grouted surfaces) are available, formulated for cleaning the tile, the grout, or both.

The products for tile, stone, and grout care (e.g., sealers and cleaners) are typically provided in a liquid form, contained in an open mouth bottle or spray bottle. The user therefore needs to dispense the liquid product directly onto the tile or grout surface, and then spread the dispensed liquid product along the surface with a rag, brush, sponge or similar application tool. Alternatively, the user can pour or spray the liquid product directly onto the rag, brush, sponge or similar application tool, and then use that application tool to spread the liquid product along the tile or grout surface. Both of these approaches can lead to inconsistent application of the liquid product and/or waste of the product. Further, the task of applying the liquid care product to perpendicular grout lines can be quite cumbersome even when using an application tool. Typically, the application tool head may have a discernable application direction (e.g., in a direction of a length of the tool's head); while this direction may readily correspond with a direction of some of the grout lines in the surface region being treated, it does not align with the grout lines perpendicular to the application direction. As a result, a user must repeatedly re-position herself or himself relative to the surface being treated and/or handle the tool in an ergonomically inefficient manner in order to apply the liquid product onto all of the grout lines in a certain area of the surface being treated. Moreover, when the surface in question is a stone or porous tile grouted surface and the user is desires to apply the liquid product to the grout lines and the porous tile or stone, an elongated application tool head otherwise oriented for accessing a grout line provides minimal coverage for the relatively large surface area of the stone or porous tile itself leading to further inefficiencies.

In addition, application of tile and grout care products to vertical tiled surfaces (e.g., showers and kitchen backsplashes) presents further challenges because the liquid product can drip down the surface. It can be especially difficult to apply liquid products to horizontal grout lines on vertical surfaces because the liquids tend to pool or run uncontrollably, and can spill onto the floor.

In light of the above, a need exists for a hand-held tool for applying a cleaning or sealing solution to a grouted tile surface in a controlled fashion and able to accommodate the physical constraints presented with many grouted tile surfaces, such as perpendicular-running grout lines, horizontal grout lines on a vertical surface, and/or porous tile or stone.

### SUMMARY

Briefly, the present disclosure provides hand-held applicator tools or devices that store a liquid cleaner, sealer or the like and can also be used to apply the liquid to the target surface. The hand-held tools of the present disclosure can be used for applying tile, stone, and grout care products or other cleaners, sealers, and the like.

Some aspects of the present disclosure relate to a hand-held tool for applying a cleaning or sealing solution to a grouted tile surface. The tool includes a container, a cap assembly, a head assembly, and an applicator body. The container includes a container body containing a supply of a solution for application to a grouted tile surface, and an exit port through which the solution is dispensed from the container body. The cap assembly defines a base, a neck, and a conduit. The base is coupled to the container body. The neck extends from the base. The conduit extends between opposing, first and second ends. The first end is fluidly open to the exit port and the second end is proximate the neck. The head assembly defines a frame, a support plate and an aperture. The frame is rotatably coupled to the neck. The support plate is maintained by the frame and defines a support face opposite a rear face. The aperture is formed in the support plate and is fluidly open to the second end of the conduit and the support face. The applicator body is retained at the support face and forms a perimeter defining a major axis and a minor axis. An outer dimension of the perimeter along the major axis is greater than the outer dimension along the minor axis. With the above construction, the solution is delivered from the exit port to the applicator body via a flow pathway defined, at least in part, by the conduit and the aperture for applying the solution to a grouted tile surface. In this regard, the pathway remains fluidly open between the exit port and the applicator body as the frame and the applicator body are rotated relative to the container. In some embodiments, the container is akin to an aerosol canister including a pressurized propellant for forcing the solution to the exit port. In other embodiments, the support face forms a plurality of grooves fluidly open to the aperture for more evenly distributing the solution along a surface of the applicator body. In related embodiments, the aperture is relative centrally located relative to at least a length of the support face, and sets of the grooves extend in opposite directions from the aperture, with each set of grooves being fluidly connected to the aperture by an orifice. In yet other embodiments, the applicator body is a rectangular pad adhered to the support face.

Other aspects in accordance with principles of the present disclosure relate to a method of applying a cleaning or sealing solution to a grouted tile surface. The method includes receiving a tool having a container and an applicator body. The container contains a supply of a solution for application to the grouted tile surface. The applicator body is rotatably supported relative to the container and forms a perimeter having a major axis and a minor axis. Further, a flow pathway is defined from the container to the applicator body. The applicator body is rotated relative to the container to a first spatial orientation of the major axis relative to the container. The solution is caused to flow through the pathway and to the applicator body with the applicator in contact with the grouted tile surface at the first spatial orientation. The flow of solution is stopped, and the applicator body is rotated relative to the container to a different, second spatial orientation of the major axis relative to the container. Finally, the solution is caused to flow through the pathway and to the applicator body with the applicator body in contact with the grouted tile surface at the second spatial orientation.

### BRIEF DESCRIPTION OF THE DRAWINGS

FIG. 1 is a perspective, rear view of hand-held tool in accordance with principles of the present disclosure for applying a cleaning or sealing solution to a grouted tile surface;

FIG. 2 is a perspective, front view of the tool of FIG. 1 with portions exploded;

FIG. 3 is a cross-sectional view of the tool of FIG. 1;

FIG. 4A is an enlarged, front perspective view of a cap assembly component useful with the tool of FIG. 1;

FIG. 4B is a enlarged, bottom perspective view of the cap assembly of FIG. 4A;

FIG. 4C is an enlarged, longitudinal cross-sectional view of a portion of the tool of FIG. 1 and illustrating features of the cap assembly of FIG. 4A;

FIG. 4D is an enlarged, longitudinal cross-section view of a portion of the tool of FIG. 1, taken along a plane 90 degrees from the plane of FIG. 4C;

FIG. 5A is an enlarged, top perspective view of a frame component of a head assembly useful with the tool of FIG. 1;

FIG. 5B is rear perspective view of the frame of FIG. 5A;

FIG. 6A is an enlarged, perspective view of an inset piece of the head assembly of FIG. 1;

FIG. 6B is a longitudinal cross-sectional view of the insert piece of FIG. 6A;

FIG. 6C is a longitudinal cross-sectional view of the insert piece of FIG. 6A, taken along a plane 90 degrees from the plane of FIG. 6B;

FIG. 7A is an enlarged, front perspective view of a head assembly useful with the tool of FIG. 1, including the frame of FIG. 5A and the insert piece of FIG. 6A;

FIG. 7B is a front view of the head assembly of FIG. 7A;

FIG. 8 is an enlarged, longitudinal cross-sectional view of a portion of the tool of FIG. 1; and

FIGS. 9A and 9B are end views illustrating use of the tool of FIG. 1.

### DETAILED DESCRIPTION OF THE INVENTION

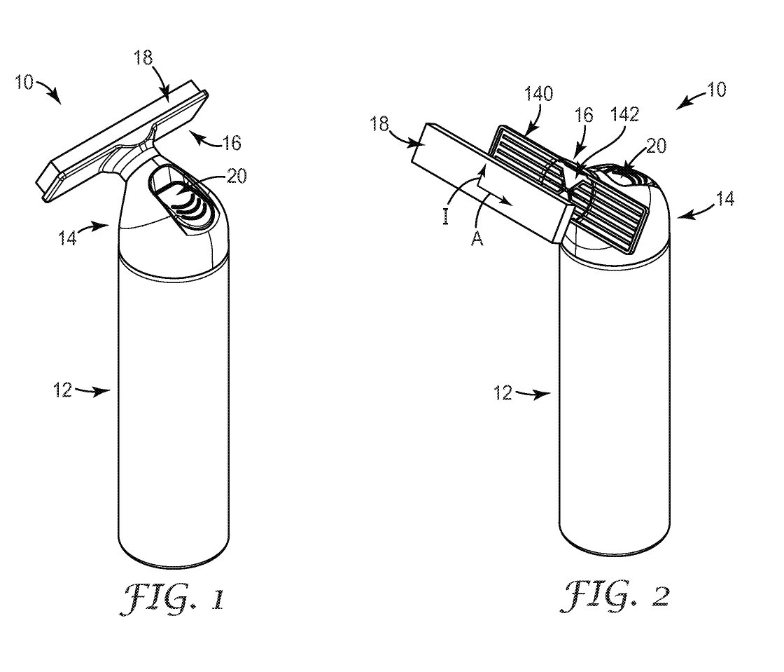

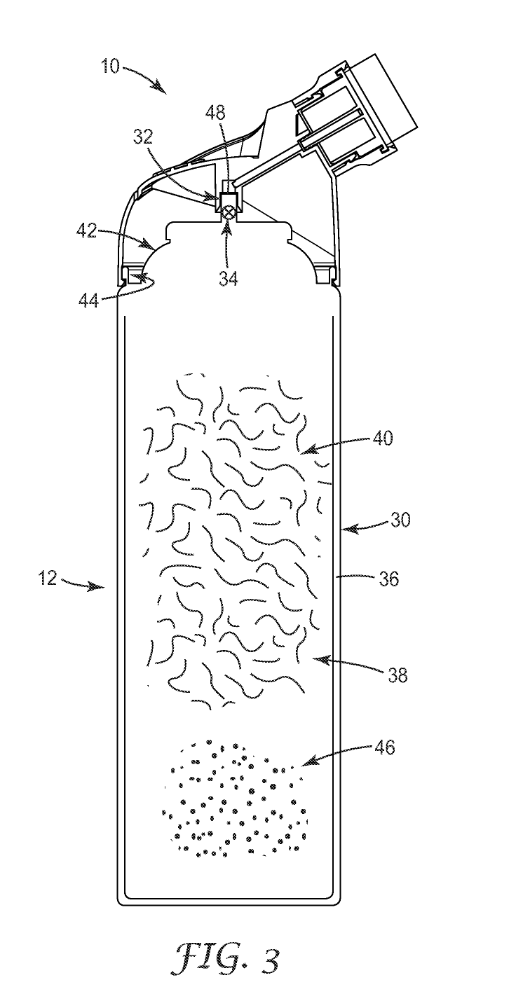

One embodiment of a hand-held tool 10 in accordance with principles of the present disclosure for applying a cleaning or sealing solution to a grouted tile surface is shown in FIGS. 1 and 2. The tool 10 includes a container 12, a cap assembly 14, a head assembly 16, and an applicator body 18. Details on the various components are provided below. In general terms, however, the container 12 contains a supply of a solution (e.g., liquid solution) formulated for treating a grouted tile surface. The cap assembly 14 is coupled to the container 12, and the head assembly 16 is rotatably associated with the cap assembly 14. The applicator body 18 is retained by the head assembly 16, Further, one or both of the cap assembly 14 and the head assembly 16 define a flow pathway (hidden in FIGS. 1 and 2) from the container 12 to the applicator body 18. With this construction, a user, otherwise grasping the tool 10 at or near the container 12, can rotate the applicator body 18 relative to the container 12 to various spatial orientations desired for a particular grouted tile surface treatment task while continuing to hold the tool 10 at the same location along the container 12. Further, an actuator member 20 (e.g., a button) can be included with the cap assembly 14 that provides the user with the ability to regulate or control the flow of solution to the applicator body 18. As a point of reference, tools of the present disclosure are useful for applying a cleaning or sealing solution to a plethora of different types of grouted tile surfaces, and find additional benefit in the treatment of stone or porous tile grouted surfaces.

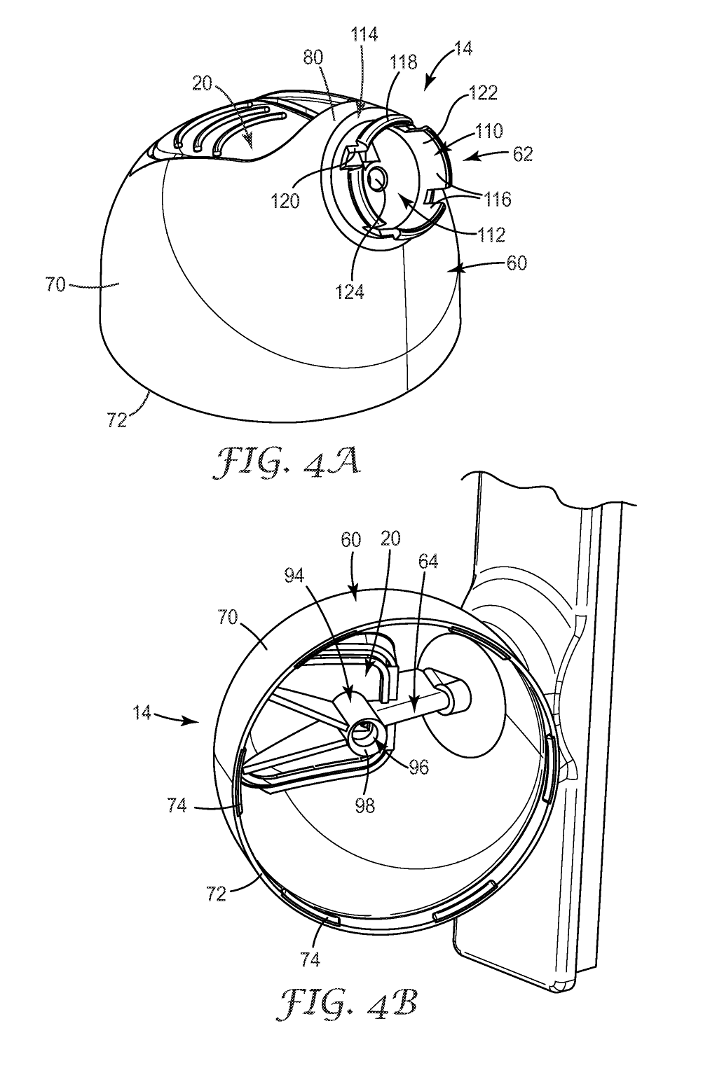

One embodiment of the container 12 is shown in greater detail in FIG. 3, and includes a container body 30, an exit port 32, and a valve mechanism 34. As a point of reference the components 30-34 are illustrated in relatively schematic form in FIG. 3, it being understood that the container 12 can assume a wide variety of forms and in some embodiments can be akin to a conventional aerosol spray canister. Thus, the container body 30 includes an outer wall 36 defining a containment region 38 (referenced generally) within which the supply of solution 40 for treating a grouted tile surface is contained. A cover 42 or similar structure is formed by or attached to the outer wall 36. In some embodiments, the outer wall 36 can have the elongated, cylindrical shape shown, although other shapes are also contemplated by the present disclosure. Further, the container body 30 forms a rim 44 configured to interface with the cap assembly 14 as described below.

With embodiments in which the container 12 is akin to an aerosol spray canister, a propellant 46 (referenced generally) as know in the art is maintained within the containment region 38 and serves as a pressure source that forces the solution 40 toward the cover 42 (and in particular to the exit port 32 carried by the cover 42). Alternatively, the container 12 can incorporate other devices that serve to either pressurize the solution 40 or otherwise force the solution toward the cover 42 that may or may not include the propellant 46. For example, the container 12 can include or be connected to a user-actuated pump (e.g., a foaming pump), a pressurized bellows, etc. In yet other embodiments, the outer wall 36 can be formed of a flexible material such that the container body 30 is akin to a squeezable bag.

As mentioned above, the exit port 32 is carried by the cover 42 and is fluidly connected to the containment region 38. The valve mechanism 34 is associated with the exit port 32 and is operable to selectively open and close a passage through the exit port 32. The exit port 32 and the valve mechanism 34 can assume a variety of forms known in the art, such as those conventionally utilized with aerosol spray canisters. With these constructions, and in general terms, the exit port 32 and the valve mechanism 34 operate in tandem, with the valve mechanism 34 normally assuming or biased to a closed state. The valve mechanism 34 is transitioned to an open state (in which the solution 40 is caused or allowed to flow through the exit port 32) by a pressing force applied to a tip 48 of the exit port 32 (e.g., a downward force relative to the orientation of FIG. 3). Upon removal of the pressing force, the exit port 32/valve mechanism 34 self-transitions back to the closed state. Other valve mechanisms known to those of ordinary skill are within the scope of the present disclosure.

The solutions 40 of the present disclosure can have a variety of different compositions or formats, and are generally formulated to seal grout or tile, clean grout or tile, or seal and clean grout and tile. The selected solution 40 is in liquid form and is readily flowable through the passage of the exit port 32. One non-limiting example of a solution or composition for treating a grouted tile surface is “Scotchgard™ Tile and Grout Multi-Surface Sealer PM-3000” available from 3M Company of St. Paul, Minn. As a point of reference, the non-limiting examples of Scotchgard™ Tile and Grout Multi-Surface Sealer PM-3000 is a water-based composition formulated with a dipropyleneglycol monomethylether and a urethane polymer modified with perfluoroalkylsulfonamide. A plethora of other grouted tile surface care solutions are also acceptable.

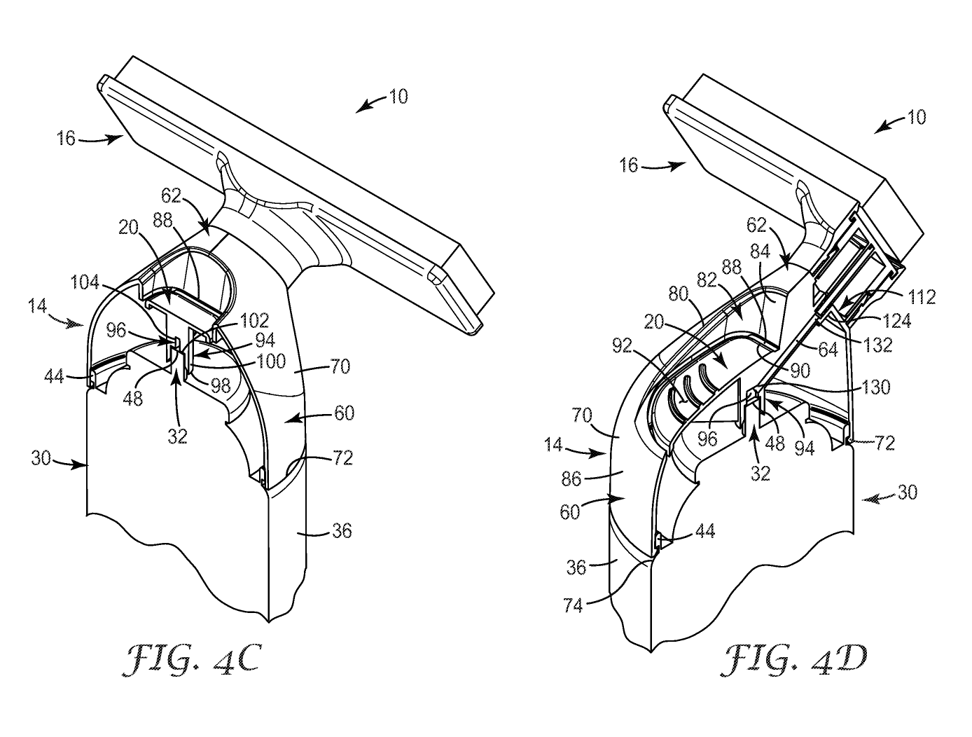

One embodiment of the cap assembly 14 in accordance with principles of the present disclosure is shown in greater detail in FIGS. 4A-4D and includes or defines a base 60, a neck 62, a conduit 64 and the actuator member 20. In some constructions, the components 20, 60-64 are integrally and homogeneously formed by a cap body (e.g., the cap assembly 14 can be an integral, plastic molded part). Alternatively, one or more of the components 20, 60-64 can be separately formed and subsequently assembled.

The base 60 includes a generally annular outer portion or wall 70 terminating at an open end 72. In some embodiments, the base 60 is configured for releasable mounting to the container body 30, and forms one or more clips 74 at the end 72 that is sized and shaped to frictionally engage the rim 44 of the container body 30. Other constructions promoting releasable mounting of the base 60 to the container body 30 are also envisioned, and do not necessarily include one or both of the rim 44 and/or the clips 74. In yet other embodiments, the base 60 is permanently assembled to, or contiguously formed by, the container body 30. Regardless, the annular outer portion 70 can be sized and shaped in accordance with a size and shape of the container body outer wall 36 (e.g., the outer wall 36 and the annular outer portion 70 have a substantially similar diameter) such that the container body 30 and the base 60 provide, upon final assembly, a relatively continuous surface for a user grasping the tool 10 in one hand and operating the actuator member 20 with their finger or thumb. Alternatively, the outer portion 70 can other shapes and/or sizes that may or may not be commensurate with those of the container body 30.

As best reflected in FIG. 4D, the base 60 forms a leading surface 80 opposite the end 72. A well 82 is defined in the leading surface 80, and optionally includes a side wall 84 projecting from the leading surface 80 toward the end 72. In some embodiments, the leading surface 80 exhibits a generally downward decline (relative to the orientation of FIG. 4D) in extension from the neck 62 to a side 86 opposite the neck 62. Regardless, the actuator member 20 is disposed within the well 82, and is associated with the leading surface 80 in a hinged fashion. For example, a living hinge 88 can be formed between an edge 90 of the actuator member 20 and the side wall 84, with a remainder of the actuator member 20 perimeter being free of attachment to other portions of the base 60. With this construction, the actuator member 20 is akin to a button. In response to a pressing force applied by a user onto an exterior face 92 of the actuator member 20, the actuator member 20 deflects inwardly relative to the base 60, pivoting at the hinge 88. As described in greater detail below, this action provides an actuating interface with the exit port 32/valve mechanism 34 (FIG. 3). Other constructions for the actuator member 20 are also envisioned that may or may not be akin to a hinged button. For example, the cap assembly 14 can format the actuator member 20 as a sliding switch, a rotating wheel, etc.

With embodiments in which the actuator member 20 is akin to a hinged button, the actuator member 20 can be connected to or contiguously formed with an inner ring 94 that is otherwise located radially within the outer portion 70. The inner ring 94 projects from the actuator member 20 in a direction generally opposite the leading surface 80 and is configured to interface with the exit port 32. For example, and as shown in FIG. 4C, the inner ring 94 forms a chamber 96 that is open at an end 98. A first section 100 of the chamber 96 adjacent the end 98 has a diameter approximating or slightly greater than a diameter of the exit port 32 such that the first section 100 can slide along an exterior of the exit port 32. A radially-inward step 102 is formed along the chamber 96, defining a second section 104 having a diameter less than that of the first section 100 and less than that of the exit port 32. The step 102 thus provides an abutment surface bearing against the exit port tip 48. A pressing force applied to the actuator member 20 is thus transferred onto the exit port 32 via the step 102, causing the exit port 32/valve mechanism 34 to transition to the open state.

With specific reference to FIG. 4A, the neck 62 extends from the base 60 and includes a hub 110, a floor 112 and a shoulder 114. In some embodiments, extension of the neck 62 is off-set from a longitudinal axis of the base 60. In other words, relative to the orientation of FIG. 4A, the hub 110 projects in a side-ward fashion from the base 60 in a manner that generally represents a continuation of the inclined orientation of the leading surface 80 described above. Other orientations of the neck 62 relative to the base 60 are also contemplated. Regardless, the hub 110 is configured for rotatable connection with corresponding components of the head assembly 16 (e.g., as in FIG. 4C), and can include a plurality of circumferentially spaced fingers 116. The fingers 116 each form a ledge 118 opposite the shoulder 114 and are circumferentially spaced from one another by gaps 120. A receptacle 122 is collectively defined by an interior surface of the fingers 116. The receptacle 122 is open opposite the base 60. The floor 112 bounds the receptacle proximate the base 60, and forms a bore 124 for reasons made clear below. The shoulder 114 circumscribes the hub 110 proximate the base 60 and provides a bearing surface for a component of the head assembly 16. Alternatively, the neck 62 can have configurations differing from those shown and designed to promote rotatable connection with the head assembly 16. Thus, the hub 110, floor 112, and the shoulder 114 are optional components and in other embodiments can be omitted.

With reference to FIG. 4D, in some embodiments the conduit 64 is defined as a passage through a thickness of the cap assembly 16 structure, and extends between opposing, first and second ends 130, 132. The first end 130 is fluidly open or connected to the chamber 96 of the inner ring 94 (and in particular the second section 104 (FIG. 4C)). The second end 132 is fluidly open or connected to the bore 124 in the floor 112. As a point of reference, the bore 124 is referenced generally in the view of FIG. 4D and is further identified in FIG. 4A. While the bore 124 can have an enlarged diameter (as compared to a diameter of the conduit 64 at the second end 132 for reasons made clear below), in other embodiments, the bore 124 and the conduit 64 can have a continuous diameter. Along these same lines, in other embodiments the bore 124 can be considered as a continuation of the conduit 62, with the second end 132 effectively being defined at the floor 112 (FIG. 4A).

With the above construction, the conduit 64 travels with movement of the inner ring 94 (via the movement of the actuator member 20 as described above) and remains permanently open to the chamber 96. Thus, solution dispensed from the exit port tip 48 into the chamber second section 104 flows directly into the conduit first end 130. The conduit 64, in turn, directs the solution flow to the second end 132, delivering the solution flow to the head assembly 16.

Returning to FIG. 2, one embodiment of the head assembly 16 includes a frame 140 and an insert piece 142. The insert piece 142 is mountable within the frame 140, with the two components collectively defining a surface for maintaining the applicator body 18 and dispensing delivered solution 40 (FIG. 3) on to the applicator body 18.

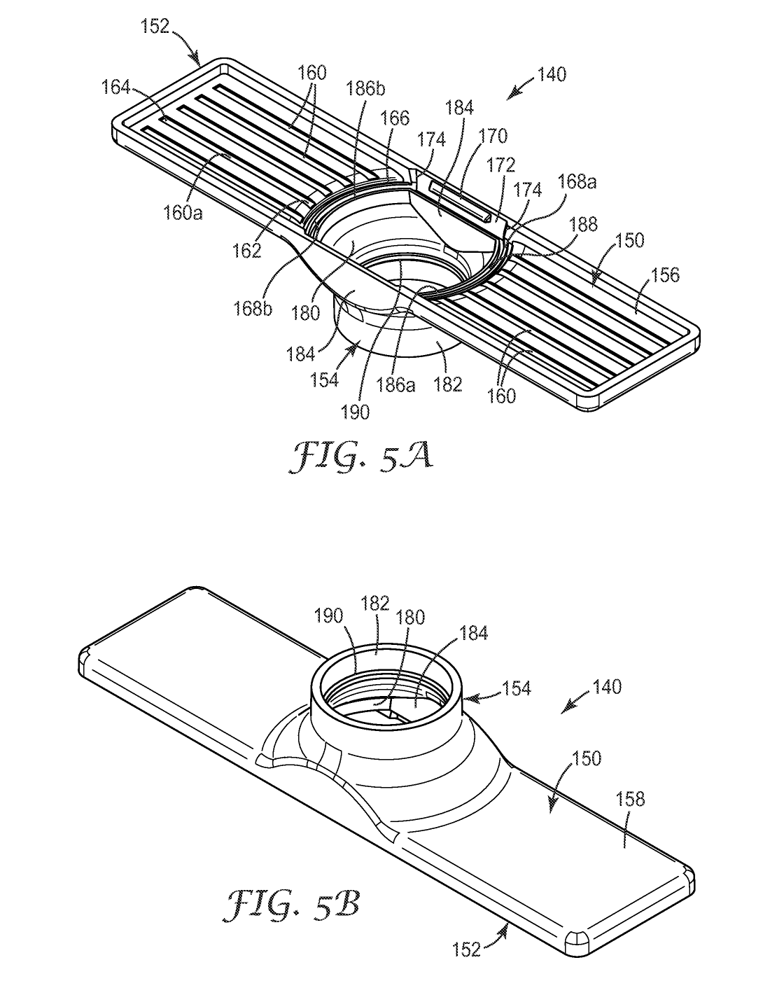

The frame 140 is shown in greater detail in FIGS. 5A and 5B, and includes or defines a table 150, a side wall 152 and a sleeve 154. The table 150 is a generally planar body defining a front surface 156 and a rear surface 158. In some embodiments, a size and shape of the table 150 corresponds with a size and shape of the applicator body 18 (FIG. 2) and thus can have the generally rectangular shape shown. Alternatively, a perimeter shape of the table 150 can differ from that of the applicator body 18, and need not be rectangular. Regardless, a plurality of groove segments 160 are defined in the front surface 156 and are open to an exterior thereof. The groove segments 160 can extend substantially parallel (e.g., within 10 degrees of a true parallel relationship) to a major axis of the frame 140 (e.g., with embodiments in which the table 150 has a rectangular shape, the groove segments 160 extend substantially parallel to a length of the rectangular shape). As identified in FIG. 5A for the groove segment 160a, each of the groove segments 160 extends between opposing first and second ends 162, 164, with the first end 162 being open to a central opening 166 in the bottom wall and the second end 164 being closely proximate the side wall 152. Finally, the table 150 optionally forms or includes arcuate projections 168a, 168b at the front surface 156 adjacent the central opening 166 for reasons made clear below.

The side wall 152 circumscribes the perimeter of the table 150, projecting from the front surface 156 in a direction opposite the rear surface 158. The side wall 152 can be configured for encompassing a portion of the applicator body 18 (FIG. 1). Optionally, the side wall 152 can carry or form clips 170 (one of which is visible in the view of FIG. 5A) within recessed areas 172 (one of which is visible in FIG. 5A). The recessed areas 172 define opposing corners 174, with the clips 170 and the corners 174 configured to capture the insert piece 142 (FIG. 2) upon final assembly. In other embodiments, the side wall 152 can be omitted.

The sleeve 154 extends from the rear surface 158 of the table 150, and is open to the central opening 166. In some embodiments, extension of the sleeve 154 defines a first region 180 and a second region 182. The first region 180 is immediately proximate the table 150, and while generally cylindrical in shape, defines flattened areas 184. The flattened areas 184 are generally aligned with a respective one of the clips 170 and serve to rotatably secure the insert piece 142 relative to the frame 140 upon final assembly. In other constructions, the flattened areas 184 can be omitted. Further, the first region 180 terminates at lips 186a, 186b projecting into the front surface 156 of the table 150. The lips 186a, 186b correspond in size and shape with the arcuate projections 168a, 168b, respectively, establishing an optional channel 188 sized to receive a feature of the insert piece 142 (FIG. 2) as described below.

The second region 182 extends from the first region 180 and can have the continuous cylindrical exterior shape shown. Further, a circumferential rib 190 can be formed as a radially inward projection along an interior of the second region 182 and configured to promote coupling with the neck 62 (FIG. 4A). In other embodiments, the rib 190 can be omitted.

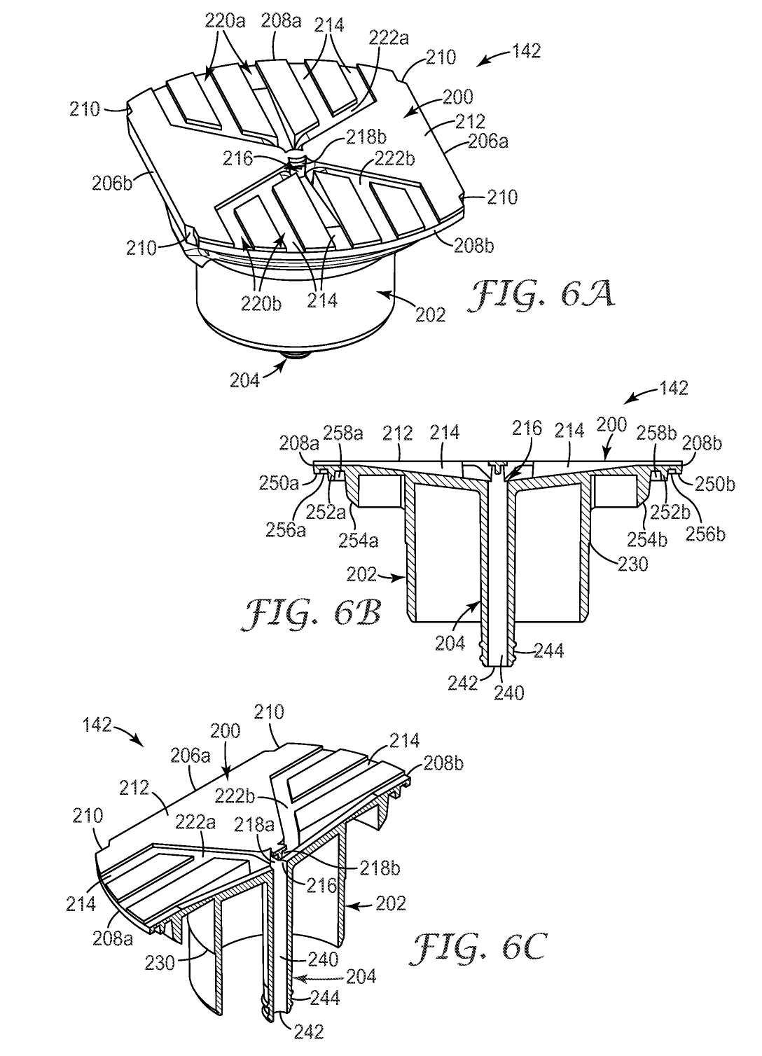

The insert piece 142 is shown in greater detail in FIGS. 6A-6C and includes or defines a platform 200, a hub 202 and a tube 204. A perimeter of the platform 200 includes opposing linear edges 206a, 206b, and opposing curved edges 208a, 208b. A notch 210 is defined at the intersection of the linear edge 206a, 206b with the corresponding curved edge 208a, 208b.

A front surface 212 of the platform 200 forms a plurality of groove segments 214 that are open to an exterior of the front surface 212 and generally correspond with the groove segments 168 (FIG. 5A) described above. An aperture 216 is further defined in the front surface 212. The aperture 216 can be centrally located relative to a shape of the platform 200 and is fluidly open to the plurality of groove segments 214 via one or more orifices 218a, 218b (best seen in FIG. 6C). For example, the plurality of groove segments 214 can be designated as defining first and second sets 220a, 220b of groove segments. The groove segments 214 of the first set 220a extend to, and are open at, the first curved edge 208a, whereas the groove segments 214 of the second set 220b extend to, and are open at, the second curved edge 208b. The first orifice 218a fluidly connects the groove segments 214 of the first set 220a with the aperture 216 via a first trough 222a extending generally transversely to a direction of extension of the groove segments 214. Similarly, the second orifice 218b fluidly connects the groove segments 214 of the second set 220b with the aperture 216 via a second trough 222b. Solution flowing into the aperture 216 is thus distributed to the groove segments 214 through the orifices 218a, 218b. A size of each of the orifices 218a, 218b is less than a size of the aperture 216 in some embodiments such that the orifices 218a, 218b effectively eject the liquid solution from the aperture 216 toward the groove segments 214. Further, the orifices 218a, 218b are generally perpendicular to a plane of the aperture 216, directing delivered liquid in a side-ward direction (relative to an axis of the aperture 216). Thus, liquid solution delivered to the aperture 216 is distributed across the front surface 212 (as opposed to be focused at the aperture 216). Alternatively, a variety of other configurations capable of distributing delivered liquid along the front surface 212 are contemplated that may include a greater or lesser number of the orifices 218a, 218b; in other embodiments, the orifices 218a, 218b can be omitted. With the but one acceptable construction of FIGS. 6A-6C however, a depth of the groove segments 214 and of the troughs 222a, 222b optionally decreases from the aperture 216 toward the platform perimeter as reflected in FIGS. 6B and 6C.

The hub 202 extends from the platform 200 opposite the front surface 212 and is substantially cylindrical. In this regard, the hub 202 is configured for mounting to the frame sleeve 154 (FIG. 5B) and can from an annular bearing surface 230 configured to interface with the base neck 62 (FIG. 4A) as described below.

As best shown in FIGS. 6B and 6C, the tube 204 extends from the platform 200 opposite the front surface 212 and is located radially inside the hub 202. The tube 204 defines a lumen 240 that is fluidly open to the aperture 216 and terminates at an end 242 opposite the aperture 216. The tube 204 can optionally define an annular slot 244 adjacent the open end 242 and sized to receive an O-ring gasket (not shown).

To facilitate coupling with the frame 140 (FIG. 5A), the insert piece 142 can further include first and second exterior flange segments 250a, 250b, first and second intermediate flange segments 252a, 252b, and first and second interior flange segments 254a, 254b as identified in FIG. 6B. Each of the first flange segments 250a, 252a, 254a are generally aligned with the first curved edge 208a, and define first and second arcuate gaps 256a, 258a. Similarly, the second flange segments 250b, 252b, 254b are generally aligned with the second curved edge 208b, and define first and second arcuate gaps 256b, 258b. A size and shape of the first arcuate gaps 256a, 256b corresponds with those of the frame arcuate projections 168a, 168b (FIG. 5A), and a size and shape of the second arcuate gaps 258a, 258b corresponds with those of the frame lips 186a, 186b (FIG. 5A). Alternatively, one or more of the flange segments 250a-254b can have a different construction or can be omitted.

With cross-reference between FIGS. 5A and 6A-6C, mounting of the insert piece 142 to the frame 140 includes the insert piece hub 202 co-axially disposed within the frame sleeve 154. The linear edges 204a, 204b of the insert piece platform 200 are aligned with respective ones of the flattened areas 184 of the frame 140, with the notches 210 of the insert piece 142 engaged by respective ones of the frame corners 174. Thus, the insert piece 142 is rotationally fixed relative to the frame 140. Further, the frame arcuate projections 168a, 168b nest within respective ones of the first arcuate gaps 256a, 256b of the insert piece, as does the frame lips 186a, 186b within the second arcuate gaps 258a, 258b, respectively. Finally, the front surface 212 of the insert piece 142 abuts the clips 170 provided with the frame 140, thereby capturing the insert piece 142 relative to the frame 140.

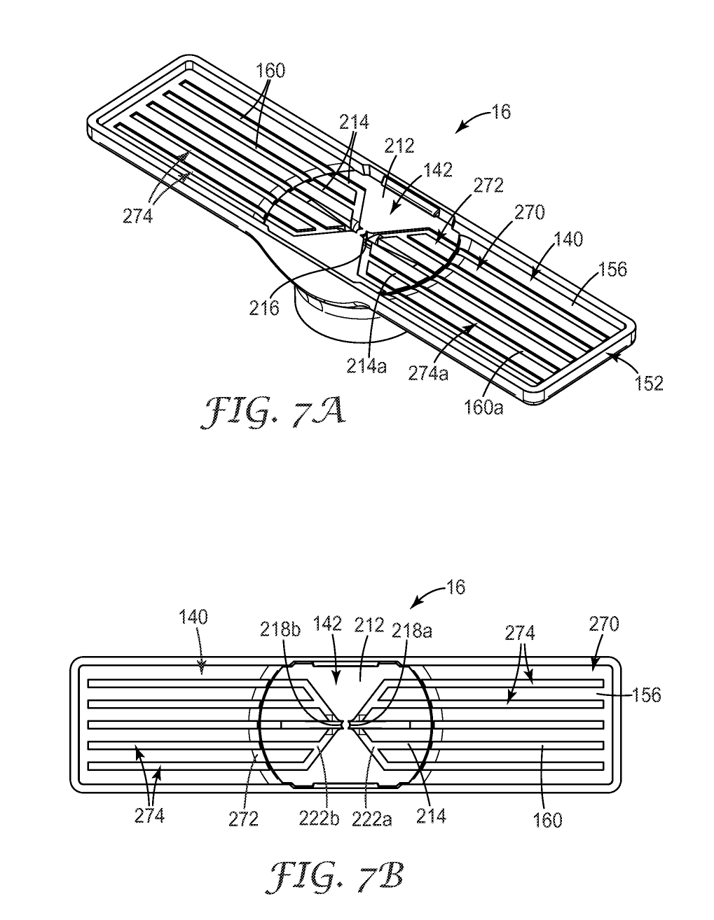

As shown in FIGS. 7A and 7B, upon final assembly of the insert piece 142 to the frame 140, the respective ones of the groove segments 160, 214 are aligned with, and fluidly open to, one another. Thus, the frame 140 and the insert piece 142 combine to form or define a support plate 270 having a support face 272 (i.e., the front surface 156 of the frame 140 and the front surface 212 of the insert piece 142 combine to define the support face 272). The support face 272 is sized and shaped to maintain the applicator body 18 (FIG. 2) and forms a plurality of grooves 274, with each of the grooves 274 being defined by an aligned pair of the groove segments 160, 214. For example, the groove 274a identified in FIG. 7A is defined by the first groove segment 214a of the insert piece 142 and the first groove segment 160a of the frame. Each of the grooves 274 are fluidly connected or open to the aperture 216 (identified generally in FIG. 7A, and better shown in FIGS. 6B and 6C), and extend to a corresponding edge of the side wall 152. With embodiments in which the frame 140 has a generally rectangular shape and the grooves 274 are formed to extend in a direction substantially parallel with major axis of the shape (e.g., the length), the grooves 274 collectively extend along or encompass at least a majority of a dimension of the major axis, optionally at least 75% of the dimension. Regardless, liquid flows to and through each of the grooves 274 from the aperture 216 via the orifices 218a, 218b (referenced generally in FIG. 7B, and better shown in FIGS. 6B and 6C) and the troughs 222a, 222b. With constructions in which at least a portion of the grooves 274 have a decreasing depth in extension away from the aperture 216 (as described above with respect to FIGS. 6B and 6C), a more uniform distribution of liquid flow along a length of the grooves 274 can be provided.

While the support plate 270 and the support face 272 have been described as collectively being defined by the separately formed frame 140 and insert piece 142 components, in other embodiments, the head assembly 16 can include a single, homogenous structure that forms the support plate 270 and the support face 272. In yet other embodiments, the support plate 270 and the support face 272 can consist of three or more separate components.

Returning to FIG. 1, the applicator body 18 can assume a variety of forms, and has a perimeter shape defining a major axis A and a minor axis I. A dimension of the perimeter along the major axis A is greater than a corresponding dimension along the minor axis I. For example, in some embodiments the applicator body 18 is a rectangular pad (e.g., a flocked pad comprised of natural and/or synthetic fibers). Alternatively, the applicator body 18 can have other shapes and/or formats. For example, the applicator body 18 can be a sponge, a nonwoven or woven web, a brush (with the individual bristles of the brush collectively defining the perimeter shape), or other construction having characteristics beneficial for applying a treatment solution to a grouted tile surface. In yet other embodiments, tools 10 of the present disclosure can include two (or more) different applicator bodies 18 carried by the head assembly 16 (e.g., a pad and a brush).

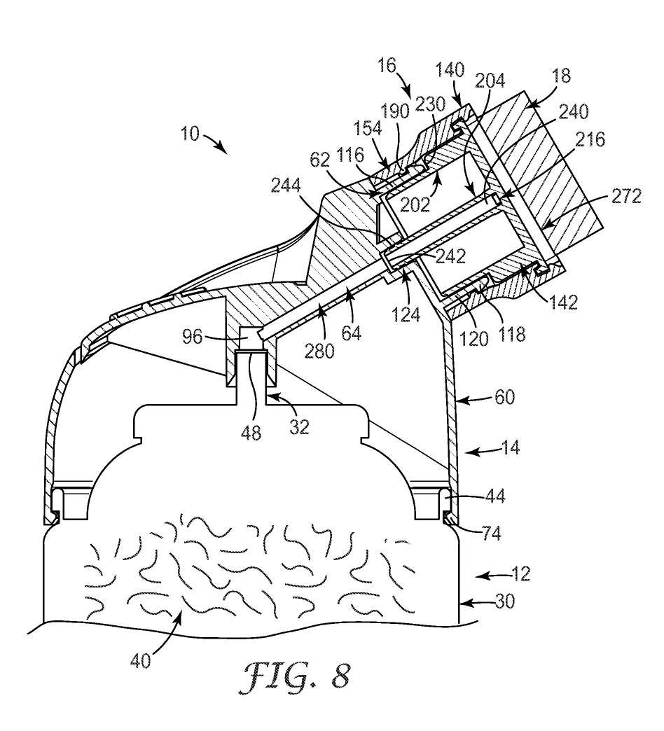

Assembly of the tool 10 is shown in FIG. 8 and includes the cap assembly 14 mounted to the container 12. In particular, the flange 74 of the base 60 is coupled to the rim 44 of the container body 30. In some constructions, the base 60 can be selectively removed from the container body 30 by simply dislodging the clips 74 from the rim 44, and then reassembling the base 60 to another, identically constructed container 12. The head assembly 16 is rotatably coupled to the cap assembly 14 by inserting the neck hub 120 between the sleeve 154 of the frame 140 and the hub 202 of the insert piece 142. The ledge 118 provided with each of the fingers 116 engages the rib 190 formed by the sleeve 154, and the bearing surface 230 of the hub 202 can abut the fingers 116 as shown. Finally, the applicator body 18 is secured to the support face 272. For example, the applicator body 18 can be bonded to the support face 272 with an adhesive, although other techniques for fixing the applicator body to the support face 272 are equally acceptable. The applicator body 18 is held at an outer-most plane of the support face 272, and does not project into an entire depth of the grooves 274. Upon final construction, the head assembly 16, and thus the applicator body 18 carried on the head assembly 16, can rotate relative to the cap assembly 14. For example, the sleeve 154 can rotate about the neck 62; because the insert piece 142 is rotationally fixed relative to the frame 140, the components 140, 142 rotate in tandem in response to a rotational force or torque imparted onto an exterior of the frame 140 (while the container body 30 and/or the base 60 is held stationary).

FIG. 8 further reflects that upon final assembly, the tube 204 is located within the hole 124. Though not shown, an O-ring or similar gasket-type body can be placed in the slot 244 to provide a fluid tight seal between the tube open end 242 and the hole 124. Regardless, the lumen 240 of the tube 204 is thus fluidly connected to the conduit 64. As a result, a fluid pathway 280 is established between the exit port tip 48 and the aperture 216, defined by the continuously open nature of the chamber 96, the conduit 64, and the tube lumen 240. Thus, as the solution 40 is released from the exit port 32, the liquid solution 40 travels through the pathway 280 to the aperture 216 and is distributed along the support face 272 as described above (via the orifices 218a, 218b and the grooves 274 shown in FIGS. 7A and 8B). The so-distributed liquid solution 40 comes into contact with a face of the applicator body 18, including along a virtual entirety of each of the grooves 274. Notably, the fluid pathway 280 remains open between the exit port tip 48 and the aperture 216 regardless of a rotational orientation of the head assembly 16 relative to the cap assembly 14. That is to say, a user can rotate the applicator body 18 to any spatial relationship relative to the container body 30 and cap assembly 14 as desired, and still dispense the liquid solution 38 on to the applicator body 18.

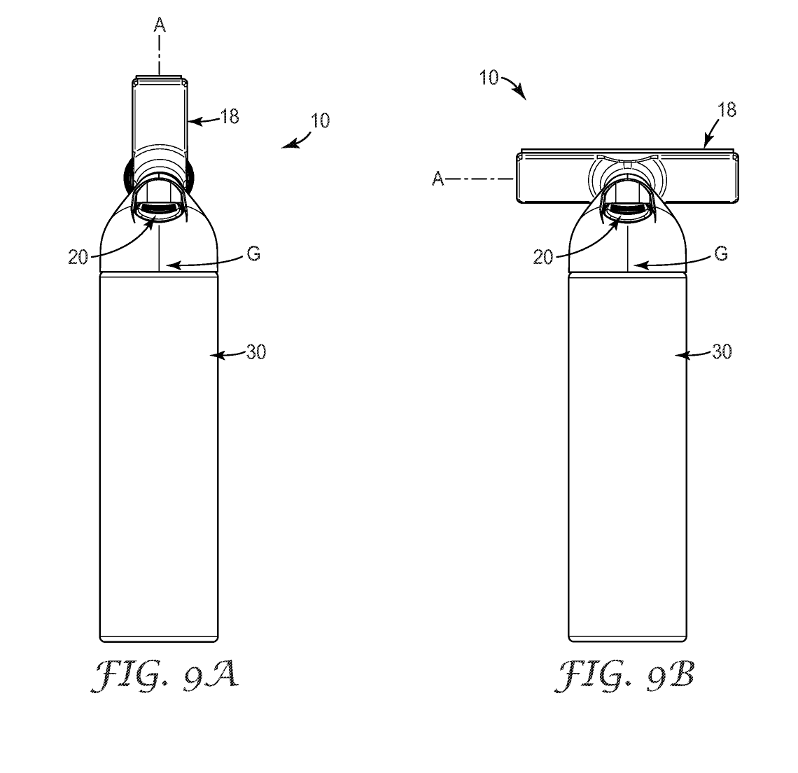

Use of the tool 10 is generally reflected in FIGS. 9A and 9B. Depending upon the particular constraints of the grouted tile surface to be treated, the applicator body 18 is arranged relative to the container body 30 at a desired spatial orientation. For example, relative to the orientation of FIG. 9A, the applicator body 18 is arranged such the major axis A is generally vertical. A user grasping the tool 10 at the region generally identified at “G” in FIG. 9A can, for example, employ the so-arranged applicator body 18 to apply the solution 40 (FIG. 3) to grout lines presented by the grouted tile surface to be treated. The user controls delivery of the solution 40 to the applicator body 18 by pressing the actuator member 20 (or other action implicated by the actuator member 20 configuration). The so-delivered solution 40 can then be applied to the grouted tile surface by contacting the applicator body 18 to the surface. Where desired, delivery of the solution 40 to the applicator body 18 can then be stopped (e.g., releasing the actuator member 20), and the applicator body 18 rotated to a different spatial orientation. For example, in the arrangement of FIG. 9B, the applicator body is arranged such that the major axis A is generally horizontal. This orientation may be more conducive (as compared to the vertical orientation of FIG. 9A) for applying the solution 40 over a larger surface area, as is typically required when caring for stone or porous tile grouted surfaces, and may be better suited for treating vertical grout lines presented by the grouted tile surface. While still grasping the tool at the same general location G, the solution 40 can again be delivered to the applicator body 18 by pressing the actuator member 20 as described above. As the solution 40 is depleted, the container 12 can be removed from the cap assembly 14 and replaced with a new container 12 having a supply of the solution 40 in some embodiments.

The hand-held applicator tools of the present disclosure provide a marked improvement over previous applicator tools employed for applying a liquid care product (e.g., sealant, cleaner, etc.) to a grouted tile surface, such as a stone or porous tile grouted surface. An applicator body carried by the tool can be arranged at virtually any desired spatial orientation relative to a handling region of the tool, thus allowing a user to easily address the constraints presented by many grouted tile surface treatment projects. Further, the user has control over delivery of the solution, with this control being provided at any spatial orientation of the applicator body.

Although the present disclosure has been described with reference to preferred embodiments, workers skilled in the art will recognize that changes can be made in form and detail without departing from the spirit and scope of the present disclosure.

What is claimed is:

1. A hand-held tool for applying a cleaning or sealing solution to a grouted tile surface, the device comprising:
a container including:
a container body containing a supply of a solution for application to a grouted tile surface,
an exit port through which the solution is dispensed from the container body;
a cap assembly defining:
a base coupled to the container body,
a neck extending from the base,
a conduit extending between opposing, first and second ends, wherein the first end is fluidly open to the exit port and the second end is proximate the neck;
a head assembly defining:
a frame rotatably coupled to the neck,
a support plate maintained by the frame and defining a support face opposite a rear face,
an aperture in the support plate and arranged to be fluidly open to the support face and the second end; and
an applicator body retained at the support face and forming a perimeter defining major and minor axes, an outer dimension of the perimeter along the major axis being greater than the outer dimension along the minor axis;
wherein the solution is delivered from the exit port to the applicator body for application to a grouted tile surface via a pathway defined, at least in part, by the conduit and the aperture, the pathway remaining fluidly open as the frame and the applicator body are rotated relative to the container body.

2. The hand-held tool of claim 1, wherein the container further includes a source of pressure within the container body and configured to force the solution toward the exit port.

3. The hand-held tool of claim 2, wherein the container further includes a valve mechanism associated with the exit port and configured to selectively allow passage of the solution from the container body through the exit port.

4. The hand-held tool of claim 3, wherein the container body, exit port and source of pressure are provided as an aerosol spray can assembly.

5. The hand-held tool of claim 1, wherein the base, neck and conduit are provided as part of a integrally-formed, homogeneous cap body.

6. The hand-held tool of claim 5, wherein the base has an annular outer portion terminating at a base end configured for removable assembly with the container body, the base further forming an inner ring radially spaced from the annular outer portion, the inner ring configured to interface with the exit port.

7. The hand-held tool of claim 6, wherein the inner ring slidably engages the exit port and defines a shoulder abutting an end of the exit port, and further wherein the container includes a valve mechanism for selectively releasing the solution through the exit port in response to a force placed on the exit port by the inner ring.

8. The hand-held tool of claim 7, wherein the base forms a leading surface opposite the base end, and further wherein the cap body defines an actuator member secured relative to the leading surface at a pivot point, and even further wherein the inner ring extends from the actuator member such that a pressing force applied to the actuator member is transferred to the exit port by the inner ring for releasing the solution through the exit port.

9. The hand-held tool of claim 6, wherein the first end of the conduit is fluidly open to an interior of the inner ring.

10. The hand-held tool of claim 1, wherein the support face defines a plurality of grooves fluidly connected to the aperture, the grooves being open relative to an exterior of the support face for distributing the solution to the applicator body from the aperture.

11. The hand-held tool of claim 10, wherein the support face defines a length and a width corresponding with the major and minor axes, respectively, of the applicator body, and further wherein the grooves are arranged to distribute the solution along at least 75% of the length.

12. The hand-held tool of claim 10, wherein the aperture is approximately centered relative to the length, and further wherein the support face defines first and second orifices open to the aperture, the first orifice fluidly connecting the aperture with a first set of the grooves extending relative to the aperture in a first direction, and the second orifice fluidly connecting the aperture with a second set of the grooves extending relative to the aperture in a second direction opposite the first direction.

13. The hand-held tool of claim 12, wherein the grooves of the first and second sets of grooves extend generally parallel with the length, and further wherein the support face defines a first side channel connecting a first end of each of the grooves of the first set of grooves with the first orifice.

14. The hand-held tool of claim 12, wherein the head assembly further includes an insert member assembled to the frame, and further wherein the insert member and the frame combine to form the support plate, including:
the insert piece forming the aperture, the orifices and an inner segment of each of the grooves; and
the frame forming an outer segment of each of the grooves;
wherein upon assembly of the insert member to the frame, each of the outer segments align with a corresponding one of the inner segments in forming the grooves.

15. The hand-held tool of claim 14, wherein the insert piece further includes a tube projecting from the aperture opposite the support face and fluidly connected to the second end of the flow passage.

16. The hand-held tool of claim 1, wherein the perimeter of the applicator body is rectangular.

17. The hand-held tool of claim 1, wherein the applicator body is selected from the group consisting of a sponge, a pad, and a brush.

18. A method of applying a cleaning or sealing solution to a grouted tile surface, the method comprising:
receiving a tool including:
a container containing a supply of a solution for application to a grouted tile surface,
an applicator body rotatably supported relative to the container and forming a perimeter defining a major axis and a minor axis,
wherein a flow pathway is defined from the container to the applicator body;
rotating the applicator body relative to the container to a first spatial orientation of the major dimension relative to the container;
causing the solution to flow through the flow pathway and to the applicator body with the applicator body in contact with the grouted tile surface at the first spatial orientation;
stopping the flow of the solution from the container to the applicator body;
rotating the applicator body relative to the container to a second spatial orientation of the major axis relative to the container, the second spatial orientation differing from the first spatial orientation; and
causing the solution to flow from through the flow pathway and to the applicator body with the applicator body in contact with the grouted tile surface at the second spatial orientation.

19. The method of claim 18, wherein the grouted tile surface includes a first grout line extending in a first direction and a second grout line extending in a second direction perpendicular to the first direction, and further wherein the first spatial orientation includes the major axis being aligned with the first grout line, and the second spatial orientation includes the major axis being aligned with the second grout line.

20. The method of claim 18, wherein the container is a pressurized canister having an exit port and a valve mechanism operable by pressing force applied to the exit port, the tool further including a head assembly maintaining the applicator body and forming an actuator, and further wherein the step of receiving the tool includes the actuator being aligned with the exit port, the method further comprising:
removing the head assembly from the canister upon depletion of the solution;
mounting the head assembly to a replacement container including the exit port;
wherein the actuator automatically aligns with the exit port of the replacement container during the step of mounting the head assembly.
